(19) United States
(12) Patent Application Publication
(10) Pub. No.: US 2013/0179690 A1
(43) Pub. Date: Jul. 11, 2013

(54) METHOD AND APPARATUS FOR FAST IMAGE ENCRYPTION AND INVISIBLE DIGITAL WATERMARK

(71) Applicant: Huaqing Wu, Norman, OK (US)

(72) Inventor: Huaqing Wu, Norman, OK (US)

(21) Appl. No.: 13/345,952

(22) Filed: Jan. 9, 2012

(51) Int. Cl. H04L 9/32; H04L 9/28

(52) U.S. Cl. 713/176; 380/28

(57) ABSTRACT

The invention is for a method and system for encrypting and decrypting image/signal, based on new column and/or row operation of the image/signal, and a new digital watermark system, based on the new encryption/decryption system. The column and row operation are introduced for creating a chaotic image/signal so that the resulting image/signal is unreadable/inaudible with a fast computational speed. The new digital watermark technology can sustain cropping damage for verification.

### CROSS-REFERENCE TO RELATED APPLICATION

This application is related to U.S. Provisional Application No. 61/277,551, filed on Sep. 28, 2009.

### BACKGROUND OF INVENTION

1. Field of Invention

A method of fast encrypting and decrypting image and data set, a method of encrypting and decrypting whole image using column and/or row operations, which are different to Fourier transform method, wavelet transform method, chaotic map method and other algebraic operations.

2. Description of Related Art

Image data security and authenticity have become more and more important thanks to the rapid development of internet and cloud computation. To protect the privacy or secrete for communicating via digital signal/image, encryption technology is needed. To provide authenticity and prevent piracy for digital image products, digital watermark technology is needed.

A gray level digital image (or black-white image) of size m×n is given by a m×n matrix with each entry value given by the intensity of the image at the location of the entry. A digital color image usually refers to a RGB image, which is the combination of three color images (red, green and blue): each of them is a gray level image. The encryption and watermark methods in this description are referred to encrypting and watermarking gray images.

A method and apparatus of image encryption is the combination of certain operations on the intensity and the location of each pixel so that the outcome image is not visible, or unreadable, or meaningless.

Digital watermark is the process of embedding authentic information into a digital image which may be used to verify its authenticity or the identity of its owner, in the same manner as paper bearing a watermark for visible identification. The embedded invisible digital watermark usually is not noticeable: Either it is invisible, or it appears meaningless.

An encryption system transfers a plaintext (the message to be encrypted) into a ciphertext (the encrypted message) via an encryption key. This is called the procedure of encryption. After the ciphertext is received through a public channel, the encryption system is used to transfer the ciphertext into a recovered plaintext via a decryption key. This is the procedure of decryption. An encryption system is also called a cipher, or a cryptosystem. There are two types of ciphers according to the relation between two cipher keys. If encryption key is the same as decryption key, the cipher is called symmetric cipher; if encryption key is different to decryption key, the cipher is called asymmetric cipher. There are also two different classes of ciphers according to the structure: block ciphers and stream ciphers. Block ciphers encrypt the plaintext block by block; stream ciphers encrypt the plaintex with a pseudo-random sequence (called keystream) controlled by the encryption key. If the plaintext is a digital image, the encryption system is called an image encryption system.

Fast image encryption systems usually are block ciphers. There are various image encryption systems: (a) Fourier transform (FT) based encryption; (b) Wavelet transform based encryption; (c) Chaotic map based encryption; (d) Other algebraic operation based encryption, as discussed in the book by A. Uhl and A. Pommer: Image and Video Encryption, Springer 2005, pp 45-127. Usually, the FT-based encryption is very efficient in making image invisible (FT transfers the information on spatial domain to information on frequency domain). Other methods are easy to implement, but are not very efficient to make image invisible, thus the speed for encryption is not fast. Most existing methods for encryption suffer from cropping damage. That is: the original image cannot be recovered from a cropped encrypted image. These encryption methods cannot be used as digital watermark technologies for the image or video that easily suffers from cropping damage.

Thus, there is a need for introducing a new encryption system that encrypts image fast and can recover the original image (or part of it) even the encrypted image has been cropped. The new system is also good for digital watermarking image that easily suffers from cropping damage.

It is well known that the diffusion process via a heat equation may blur a given image u(x,y). See, for example, G. Aubert and P. Kornprobst, Mathematical Problems in Image Processing, Springer 2002, pp 85-86, and pp 252-253.

A heat equation with Dirichlet boundary condition is defined as

$$\{ \begin{matrix}{v}_{t} ( x , y , t ) = {v}_{xx} ( x , y , t ) + {v}_{yy} ( x , y , t ) & on ( 0 , a ) \times ( 0 , b ) \times ( 0 , ∞ ) \\ v ( x , y , 0 ) = u ( x , y ) & for ( x , y ) ∈ ( 0 , a ) \times ( 0 , b ) \\ v ( 0 , y , t ) = u ( 0 , y ) , v ( a , y , t ) = u ( a , y ) ; & v ( x , 0 , t ) = u ( x , 0 ) , v ( x , b , t ) = u ( x , b ) .\end{matrix} \qquad ( 1 )$$

However, it is also well known that the backward heat equation is an ill-posed problem, thus cannot be used to decrypt the encrypted image. See, for example, W. Strauss, Partial Differential Equation, 2^{nd} edition, Wiley 2007, pp 54-55. Serious modification is needed in order to apply heat equation for image encryption.

Let the background of a given gray level image u(x,y) be a square: Ω=(0, a)×(0, b). Let a=lΔx, b=mΔy, and Δx=Δy. The discrete form of the image is given by

u_{i,j}⁰=u(iΔx,jΔy), for i=1, . . . ,l; j=1, . . . ,m.

The heat equation (1) can be approximated by evolving the image along x-direction:

u_{i,j}ⁿ⁺¹=δ(u_{i+1,j}ⁿ+u_{i-1,j}ⁿ)+(1−2δ)u_{i,j}ⁿ, u_{1,j}ⁿ=u_{1,j}⁰, u_{l,j}ⁿ=u_{l,j}⁰; (2)

Or along y-direction:

u_{i,j}ⁿ⁺¹=δ(u_{i,j+1}ⁿ+u_{i,j+1}ⁿ)+(1−2δ)u_{i,j}ⁿ, u_{i,1}ⁿ=u_{i,1}⁰, u_{i,m}ⁿ=u_{i,m}⁰, (3)

where u_{i,j}ⁿ is used to approximate ν(iΔx,jΔy,nΔt), δ=Δt/Δx² is the step length for iteration. See, for example, G. Aubert and P. Kornprobst, Mathematical Problems in Image Processing, Springer 2002, pp 230-232. It is also well known that for δ>½, the above iterations may not converge. See, for example, G. Aubert and P. Kornprobst, Mathematical Problems in Image Processing, Springer 2002, pp 233-234. Therefore, it is possible to generate invisible image through the iteration with δ>½.

Iteration (2) can also be represented by a linear system:

$$( \begin{matrix}{u}_{2 , j}^{n + 1} - δ {u}_{1 , j}^{n + 1} \\ {u}_{3 , j}^{n + 1} \\ ⋮ \\ {u}_{l - 2 , j}^{n + 1} \\ {u}_{l - 1 , j}^{n + 1} - δ {u}_{l , j}^{n + 1}\end{matrix} ) = {A}_{( l - 2 ) \times ( l - 2 )} \cdot ( \begin{matrix}{u}_{2 , j}^{n} \\ {u}_{3 , j}^{n} \\ ⋮ \\ {u}_{l - 2 , j}^{n} \\ {u}_{l - 1 , j}^{n}\end{matrix} ) , \\ where \\ {A}_{( l - 2 ) \times ( l - 2 )} = ( \begin{matrix}1 - 2 δ & δ & 0 & … & 0 & 0 \\ δ & 1 - 2 δ & 0 & … & 0 & 0 \\ … & … & … & … & … & … \\ 0 & 0 & 0 & … & 1 - 2 δ & δ \\ 1 - 2 δ & δ & 0 & … & δ & 1 - 2 δ\end{matrix} ) ; \qquad ( {4}_{x} )$$

And iteration (3) can also be represented by a linear system:

$$( \begin{matrix}{u}_{i , 2}^{n + 1} - δ {u}_{i , 1}^{n + 1} \\ {u}_{i , 3}^{n + 1} \\ ⋮ \\ {u}_{i , m - 2}^{n + 1} \\ {u}_{i , m - 1}^{n + 1} - δ {u}_{i , m}^{n + 1}\end{matrix} ) = {B}_{( m - 2 ) \times ( m - 2 )} ( \begin{matrix}{u}_{i , 2}^{n} \\ {u}_{i , 3}^{n} \\ ⋮ \\ {u}_{i , m - 2}^{n} \\ {u}_{i , m - 1}^{n}\end{matrix} ) , \\ where \\ {B}_{( m - 2 ) \times ( m - 2 )} = ( \begin{matrix}1 - 2 δ & δ & 0 & … & 0 & 0 \\ δ & 1 - 2 δ & 0 & … & 0 & 0 \\ … & … & … & … & … & … \\ 0 & 0 & 0 & … & 1 - 2 δ & δ \\ 1 - 2 δ & δ & 0 & … & δ & 1 - 2 δ\end{matrix} ) ; \qquad ( {4}_{y} )$$

Using equation (4ₓ) or (4_{y}) with a chosen δ>½, we can encrypt an image. However, there are two drawbacks. (a) Matrix A_{(l-2)×(l-2)} and B_{(m-2)×(m-2)} may not be invertible. Thus we cannot decrypt the encrypted image. (b) Even the matrix is invertible; the size of the matrix usually is too large so that the computation speed is slow. We will further modify the above iterations so that each iteration is invertible, and the matrix operation is avoided.

### SUMMARY OF THE INVENTION

We encrypt a given image u_{i,j}⁰ along x-direction through only column operations as follows. Assume that l is an even number, otherwise we can delete the first or the last column of the image. Define iteration for backward difference heat equation with a specially chosen δ=½:

u_{1,j}ⁿ=u_{1,j}⁰ for all n; u_{2k+1,j}ⁿ=2u_{2k-1,j}ⁿ for k=1, . . . ,l/2−1; (5ₒ)

and

u_{l,j}ⁿ=u_{l,j}⁰ for all n; u_{l-2k,j}ⁿ=2u_{l-2k+1,j}ⁿ⁺¹−u_{l-2k+2,j}ⁿ for k=1, . . . ,l/2−1. (5ₑ)

Equation (5ₒ) indicates that we can recover all odd columns from first column after one step of backward diffusion procedure (i.e. we can solve backward heat equation with Dirichlet boundary condition for all odd columns). Equation (5ₑ) indicates that we can recover all even columns from the last column after one step of backward diffusion procedure.

Since one of the coefficients in equations (5ₒ) and (5ₑ) is 2, which is bigger than 1, we know that above backward iteration shall create “blowup” sequences (the resulting sequence may not be bounded as the iteration goes on). We thus use equations (5ₒ) and (5ₑ) to encrypt an image along x-direction by using negative integer n: u_{i,j}⁰ is the original image, u_{i,j}⁻¹ is the encrypted image after first iteration, and u_{i,j}⁻ⁿ is the encrypted image after nth iteration.

Assume that m is an even number, otherwise we can delete the first or the last row of the image. We encrypt an image u_{i,j}⁰ along y-direction by

$$\begin{matrix}{u}_{i , 1}^{n} = {u}_{i , 1}^{0} for all n ; \\ {u}_{i , 2 k + 1}^{n} = 2 {u}_{i , 2 k}^{n + 1} - {u}_{i , 2 k - 1}^{n} \\ for k = 1 , … , \frac{m}{2} - 1 ; \\ and & ( {6}_{o} ) \\ {u}_{i , m}^{n} = {u}_{i , m}^{0} for all n ; \\ {u}_{i , m - 2 k}^{n} = 2 {u}_{i , m - 2 k + 1}^{ n + 1} - {u}_{i , m - 2 k + 2}^{n} \\ for k = 1 , … , \frac{m}{2} - 1. & ( {6}_{e} )\end{matrix}$$

An image can also be encrypted using combination of equations (5ₒ)-(5ₑ) and (6ₒ)-(6ₑ). The special combination (r,s) (number of iteration along x-direction is r, and number of iteration along y-direction is s) can be used as the encryption key.

The encrypted image along x-direction can be decrypted via heat equation (2) with δ=½:

u_{i,j}ⁿ⁺¹=½(u_{i+1,j}ⁿ+u_{i-1,j}ⁿ), u_{1,j}ⁿ=u_{1,j}⁰, u_{l,j}ⁿ=u_{l,j}⁰; (7)

The encrypted image along y-direction can be decrypted via heat equation (3) with δ=½:

u_{i,j}ⁿ⁺¹=½(u_{i,j+1}ⁿ+u_{i,j-1}ⁿ), u_{i,1}ⁿ=u_{i,1}⁰, u_{i,m}ⁿ=u_{i,m}⁰. (8)

For an encrypted image with key (r,s), we decrypt it along x-direction r times, and along y-direction times. Thus the new encryption system is a symmetric system.

The new system of encryption and decryption uses row and/or column operations, thus has fast computational speed.

The decryption procedure is based on neighborhood rows or columns, thus the partial information can be recovered from a cropped encrypted image, which is especially important in the application of digital watermark. For digital watermark, an add-on mark is encrypted first, and then encrypted mark with reduced intensity (invisible) is added on a given image.

To recover the digital mark, one first computes the difference between the original image and the watermarked image, then decrypts the difference image, and increases the intensity so that the watermark is visible.

### BRIEF DESCRIPTION OF DRAWINGS

FIG. 1 is the flow diagram illustrating how to encrypt a given image using key (r, s): iterate the procedure along x-direction r times, along y-direction s times.

FIG. 2A is a figure to show how to obtain the third column from the first column (of original image) and the second column of the image from previous iteration of encryption.

FIG. 2B is a figure to show how to obtain other odd column from the column that is two column before it (which is obtained in previous step) and the column before it from previous iteration of encrypting image.

FIG. 2C is a figure to show how to obtain the third column to the last from the last column (of original image) and the second column to the last of the image from previous iteration of encryption.

FIG. 2D is a figure to show how to obtain other even column from the column that is two column after it (which is obtained in previous step) and the column that is one column after it from previous iteration of encrypting image.

FIG. 3A is a figure to show how to obtain the third row from the first row (of original image) and the second row of the image from previous iteration of encryption.

FIG. 3B is a figure to show how to obtain other odd row from the row that is two row above it (which is obtained in previous step) and the row above it from previous iteration of encrypting image.

FIG. 3C is a figure to show how to obtain the third row to the last from the last row (of original image) and the second row to the last of the image from previous iteration of encryption.

FIG. 3D is a figure to show how to obtain other even row from the row that is two row below it (which is obtained in previous step) and the row that is one row below it from previous iteration of encrypting image.

FIG. 4A is the flow diagram illustrating how to decrypt an encrypted image using key (r, s): iterate the procedure along x-direction r times, along y-direction s times.

FIG. 4B is a figure to show how to obtain the middle column from two columns besides it.

FIG. 4C is a figure to show how to obtain the middle row from two rows above and below it.

FIG. 5A is the flow diagram illustrating how to obtain an invisible watermark image.

FIG. 5B is a figure to show how to obtain an invisible watermarked image.

FIG. 5C is the figure to show how to recover the watermark from an image with digital watermark.

FIG. 6A is a figure to show the result of the standard Lena picture being encrypted with key (2, 3).

FIG. 6B is a figure to show that part of original image can be recovered from a cropped encrypted image from FIG. 6A (part of the encrypted image).

### DETAILED DESCRIPTION

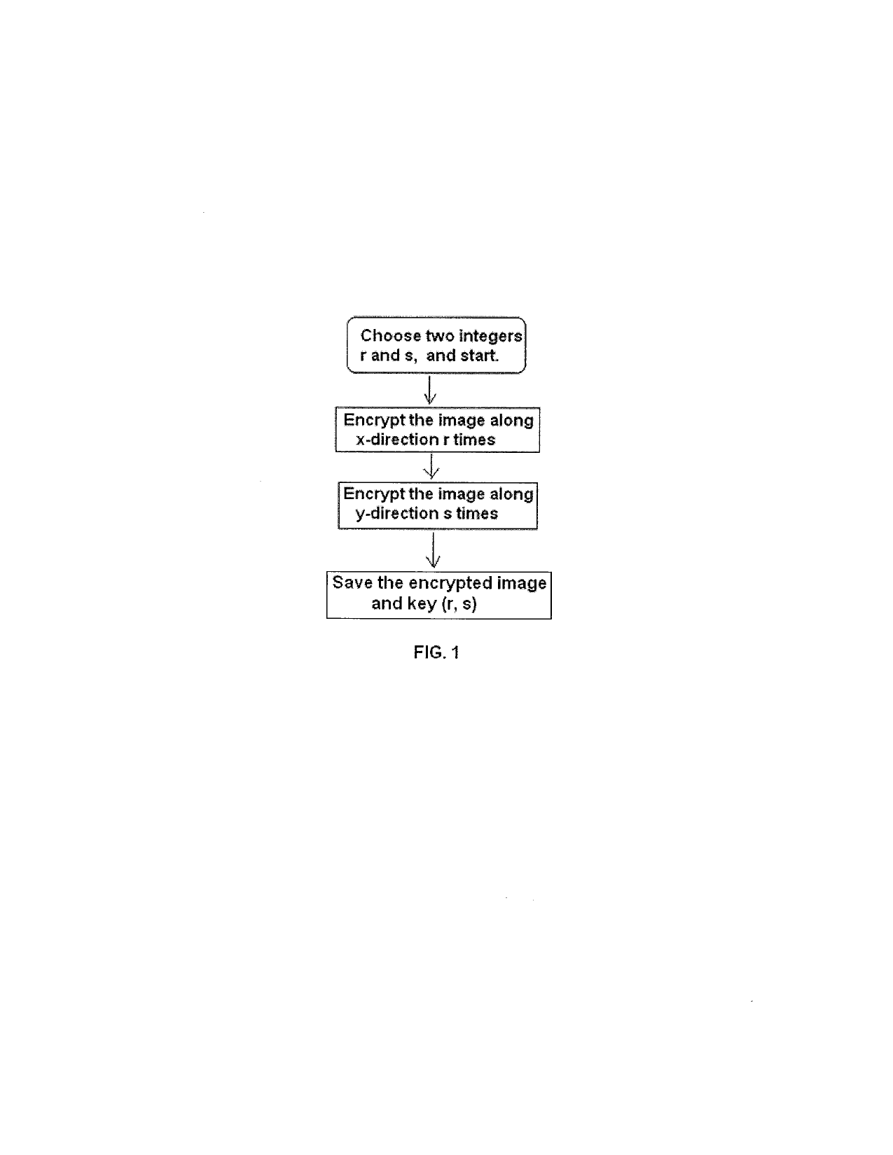

Referring now to the drawings, and more particularly to FIG. 1, shown therein is the flow chat for the new image encryption method. To carry out the encryption, one first chooses two integer combination (r, s). r refers to encrypting a given image along x-direction r times; s refers to encrypting a given image along y-direction s times. Save the key (r, s) for decryption later.

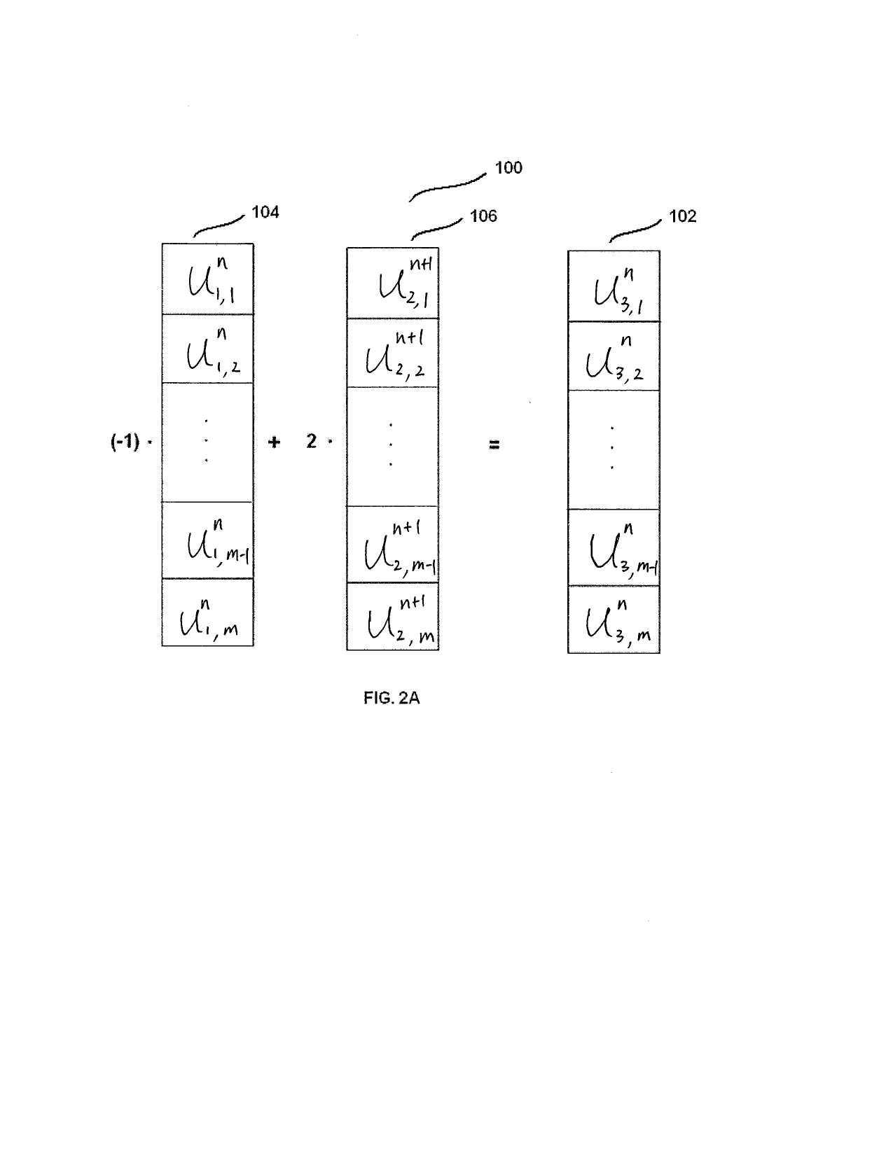

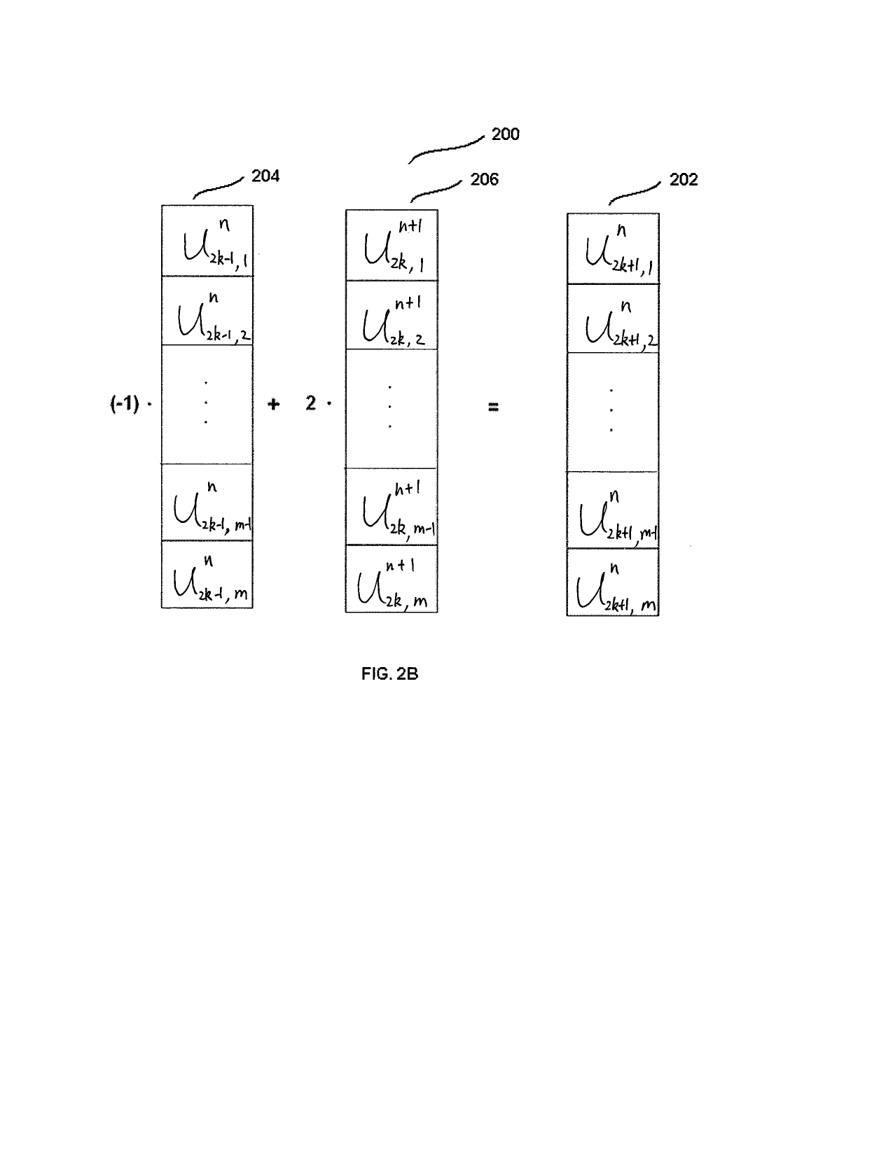

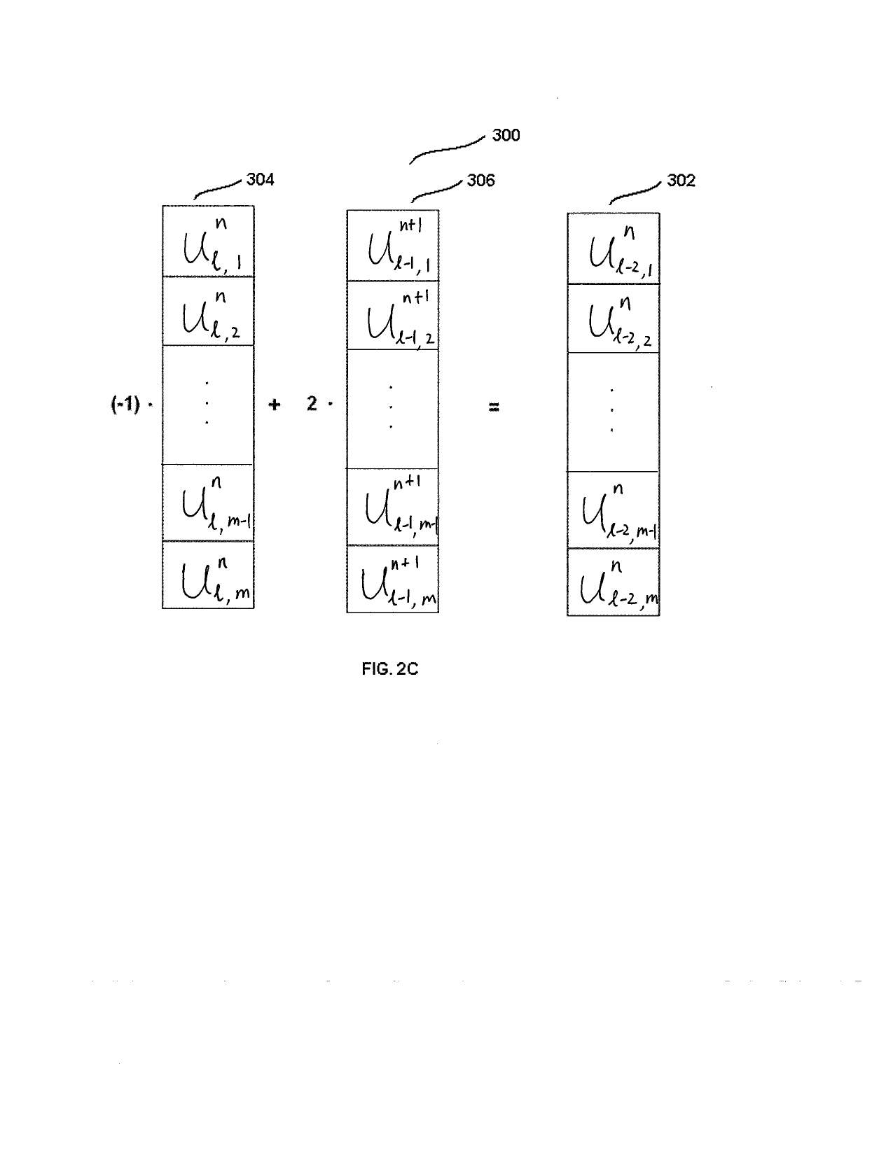

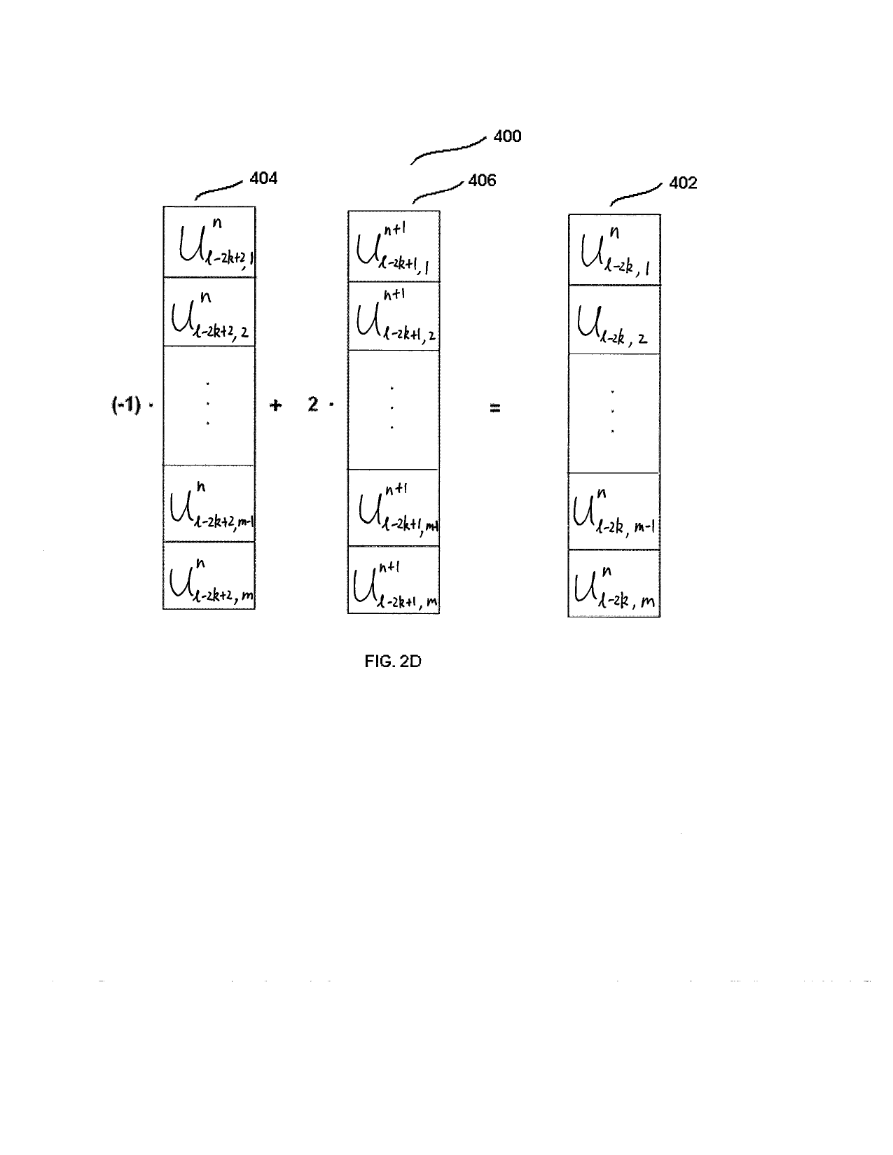

FIG. 2A-FIG. 2D are figures to show one iteration of encrypting a given image along x-direction.

FIG. 2A is a diagram to show how to obtain the third column. In this embodiment, the third column (column 102) is the summation of negative one of the first column of the given image (column 104) and twice of the second column (column 106) from the original image or previous iteration. For example, for the first iteration of encryption, we use n=−1. So we choose the first column of the given image as column 104, and the second column of the given image as column 106 to obtain new third column 102. For the second iteration, we use n=−2. Thus we choose the first column of the given image as column 104, and the second column from the image obtained from the first iteration as column 106 to obtain the new third column 102.

FIG. 2B is a diagram to show how to obtain a general odd column. After we obtain the third column, the new fifth column is the summation of negative one of the new third column and twice of the fourth column from the original image or previous iteration. For example, for the first iteration of encryption, we use n=−1, k=2. So we choose the new third column as column 204, and the fourth column of the given image as column 206 to obtain new fifth column 202. For the second iteration, we use n=−2, k=2. Thus we choose the first column of the given image as column 204, and the fourth column from the image obtained from the first iteration as column 206 to obtain the new fifth column 202. The seventh, ninth columns, etc are obtained in the same manner.

FIG. 2C is a diagram to show how to obtain the third column to the last. In this embodiment, the third column to the last (column 302) is the summation of negative one of the last column of the given image (column 304) and twice of the second column to the last (column 306) from the original image or previous iteration. For example, for the first iteration of encryption, we use n=−1. So we choose the last column of the given image as column 304, and the second column to the last of the given image as column 306 to obtain new third to the last column 302. For the second iteration, we use n=−2. Thus we choose the last column of the given image as column 304, and the second to the last column of the image obtained from the first iteration as column 306 to obtain new third to the last column 302.

FIG. 2D is a diagram to show how to obtain a general even column. After we obtain the third column to the last, the new fifth column to the last is the summation of negative one of the new third column to the last and twice of the fourth column to the last from the original image or previous iteration. For example, for the first iteration of encryption, we use n=−1, k=2. So we choose the new third column to the last as column 404, and the fourth column to the last of the given image as column 406 to obtain new fifth to the last column 402. For the second iteration, we use n=−2, k=2. Thus we use the new third to the last column as column 404, and the fourth to the last column of the image obtained from first iteration as column 406 to obtain new fifth to the last column 402. The seventh to the last, ninth to the last columns, etc. are obtained in the same manner.

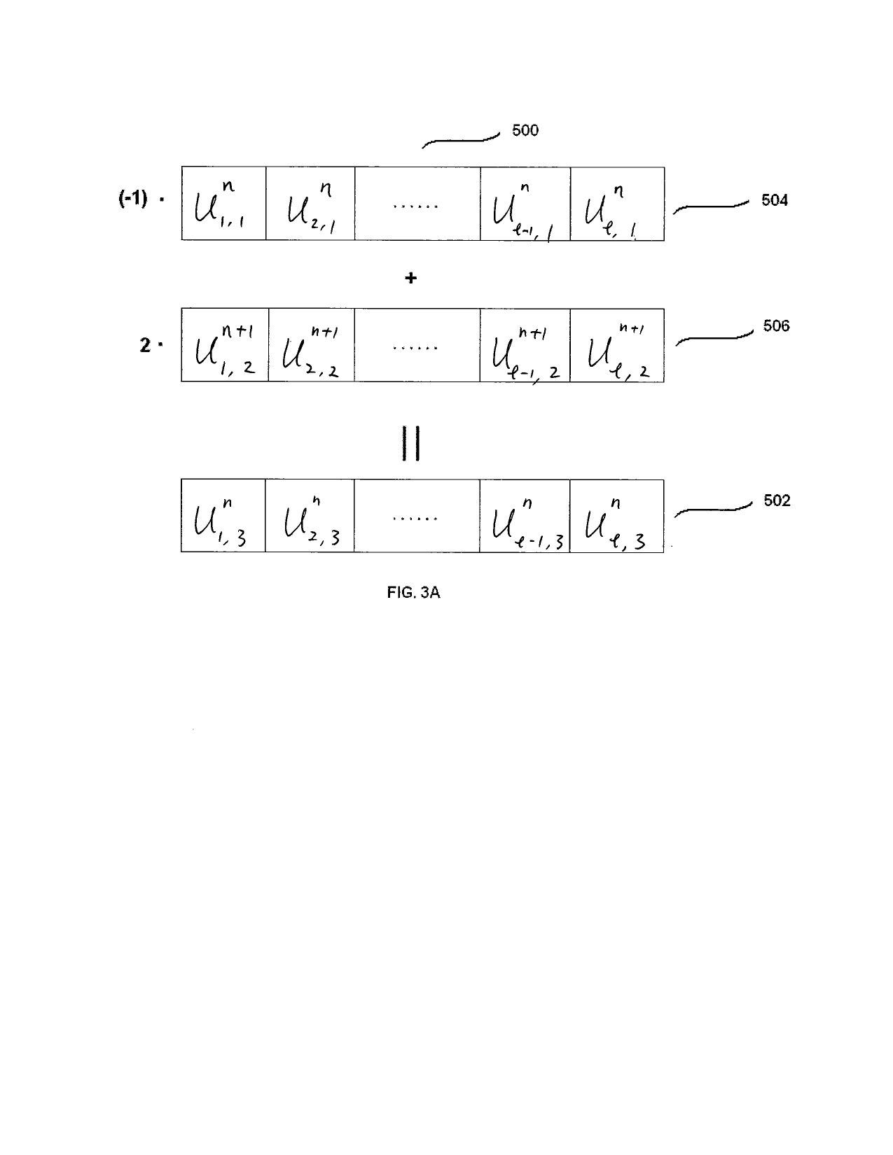

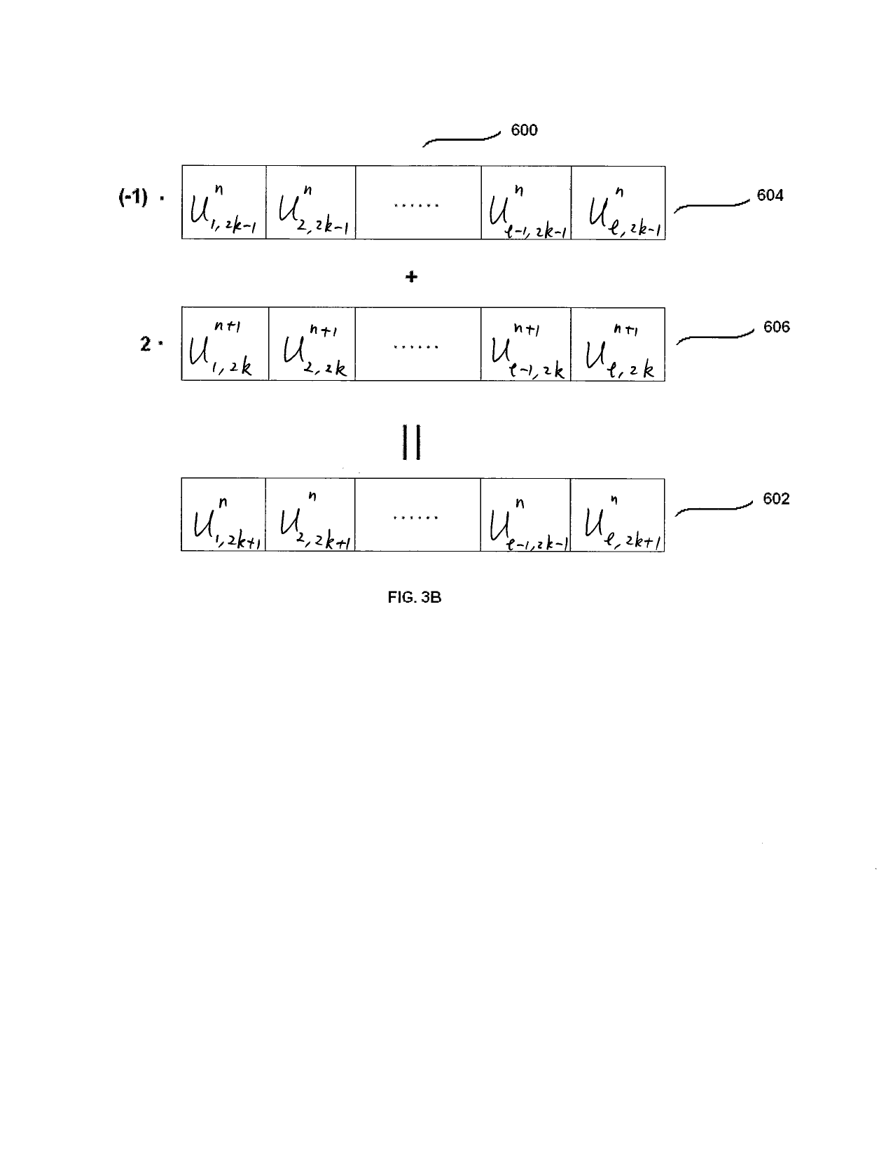

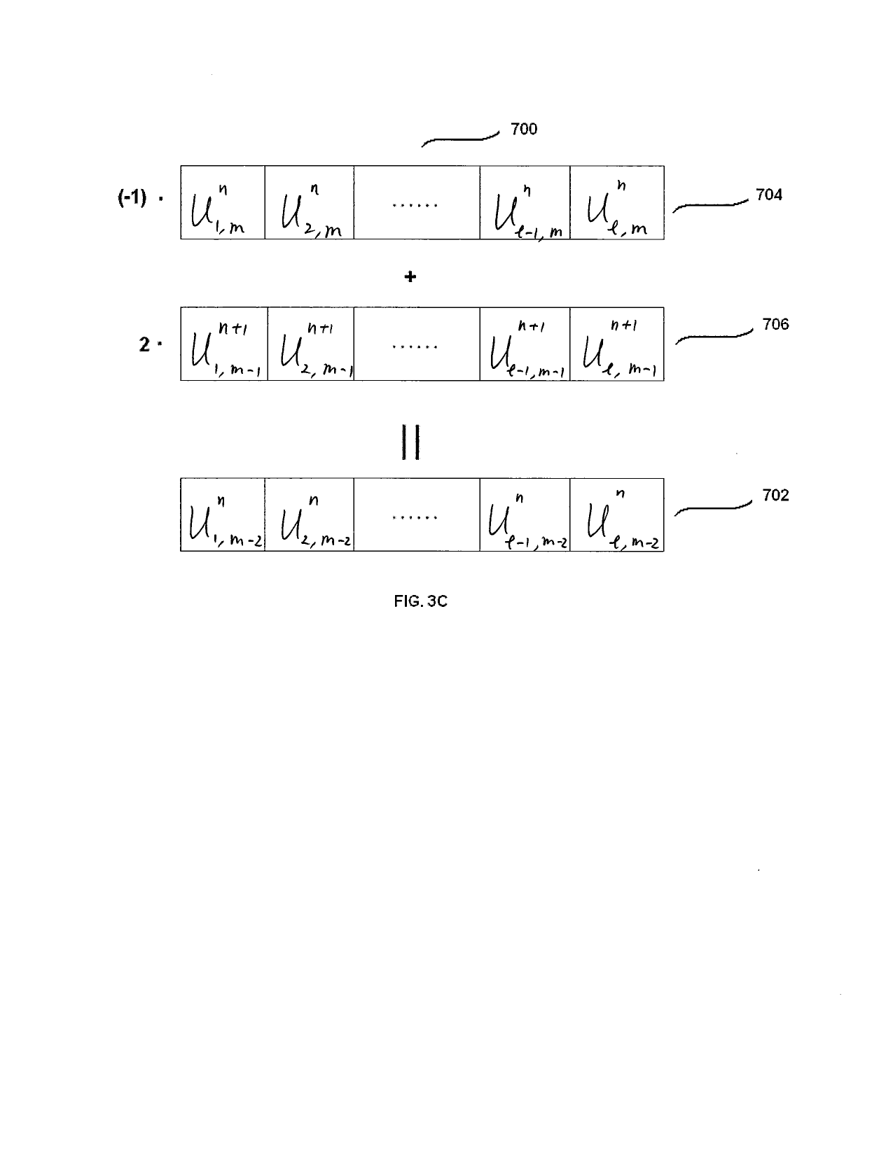

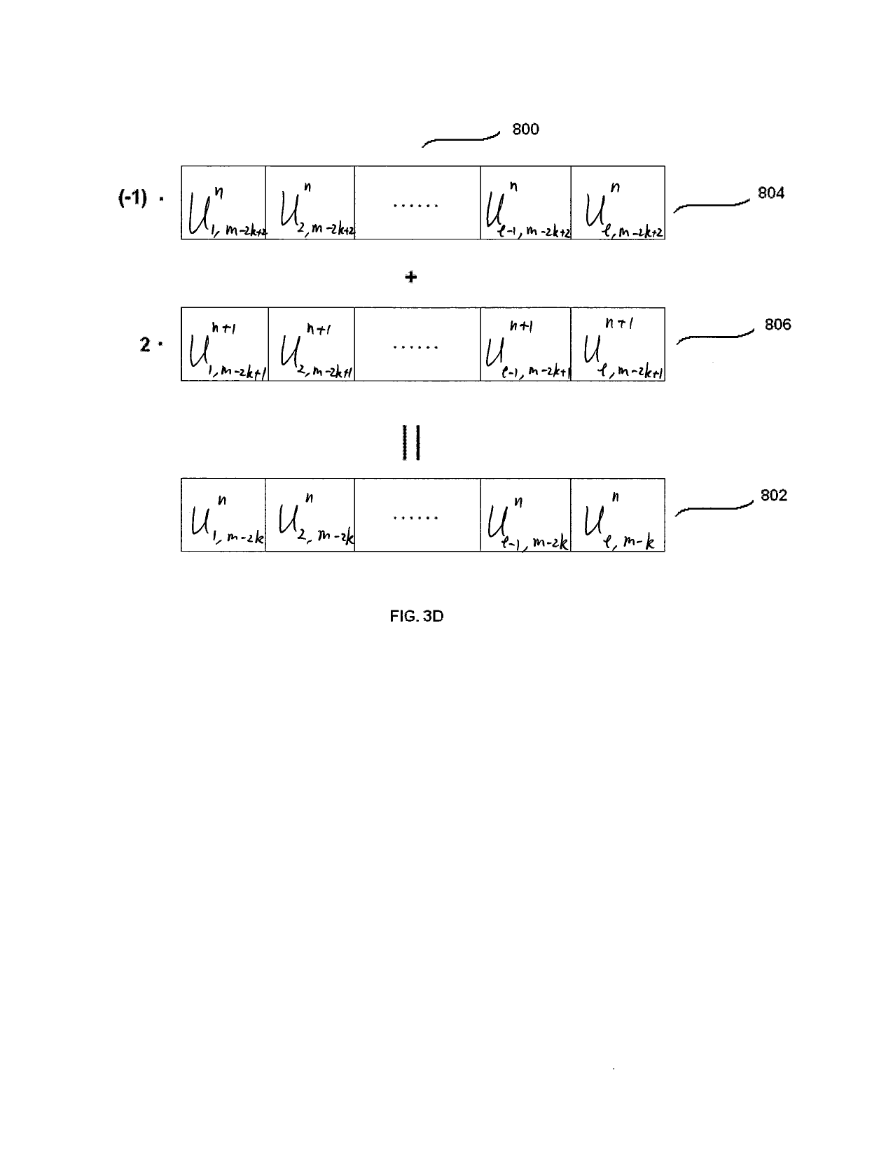

FIG. 3A-FIG. 3D are figures to show one iteration of encrypting a given image along y-direction.

FIG. 3A is a diagram to show how to obtain the third row. In this embodiment, the third row (row 502) is the summation of negative one of the first row of the given image (row 504) and twice of the second row (row 506) from the original image or previous iteration. For example, for the first iteration of encryption, we use n=−1. So we choose the first row of the given image as row 504, and the second row of the given image as row 506 to obtain new third row 502. For the second iteration, we use n=−2. Thus we choose the first row of the given image as row 504, and the second row from the image obtained from the first iteration as row 506 to obtain the new third row 502.

FIG. 3B is a diagram to show how to obtain a general odd row. After we obtain the third row, the new fifth row is the summation of negative one of the new third row and twice of the fourth row from the original image or previous iteration. For example, for the first iteration of encryption, we use n=−1, k=2. So we choose the new third row as row 604, and the fourth row of the given image as row 606 to obtain new fifth row 602. For the second iteration, we use n=−2, k=2. Thus we choose the first row of the given image as row 604, and the fourth row from the image obtained from the first iteration as row 606 to obtain the new fifth row 602. The seventh, ninth rows, etc are obtained in the same manner.

FIG. 3C is a diagram to show how to obtain the third row to the last. In this embodiment, the third row to the last (row 702) is the summation of negative one of the last row of the given image (row 704) and twice of the second row to the last (row 706) from the original image or previous iteration. For example, for the first iteration of encryption, we use n=−1. So we choose the last row of the given image as row 704, and the second row to the last of the given image as row 706 to obtain new third to the last row 702. For the second iteration, we use n=−2. Thus we choose the last row of the given image as row 704, and the second to the last row of the image obtained from the first iteration as row 706 to obtain new third to the last row 702.

FIG. 3D is a diagram to show how to obtain a general even row. After we obtain the third row to the last, the new fifth row to the last is the summation of negative one of the new third row to the last and twice of the fourth row to the last from the original image or previous iteration. For example, for the first iteration of encryption, we use n=−1, k=2. So we choose the new third row to the last as row 804, and the fourth row to the last of the given image as row 806 to obtain new fifth to the last row 802. For the second iteration, we use n=−2, k=2. Thus we use the new third to the last row as row 804, and the fourth to the last row of the image obtained from the first iteration as row 806 to obtain new fifth to the last row 802. The seventh to the last, ninth to the last rows, etc. are obtained in the same manner.

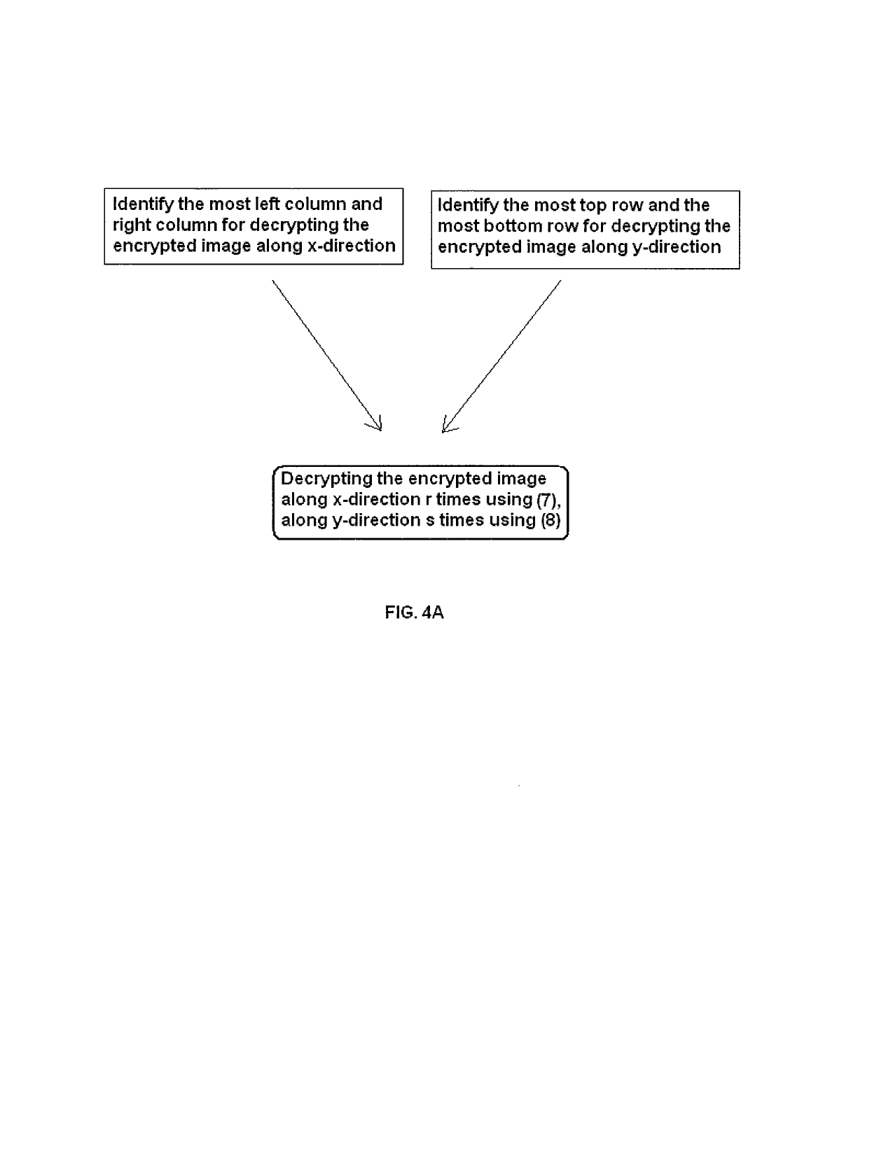

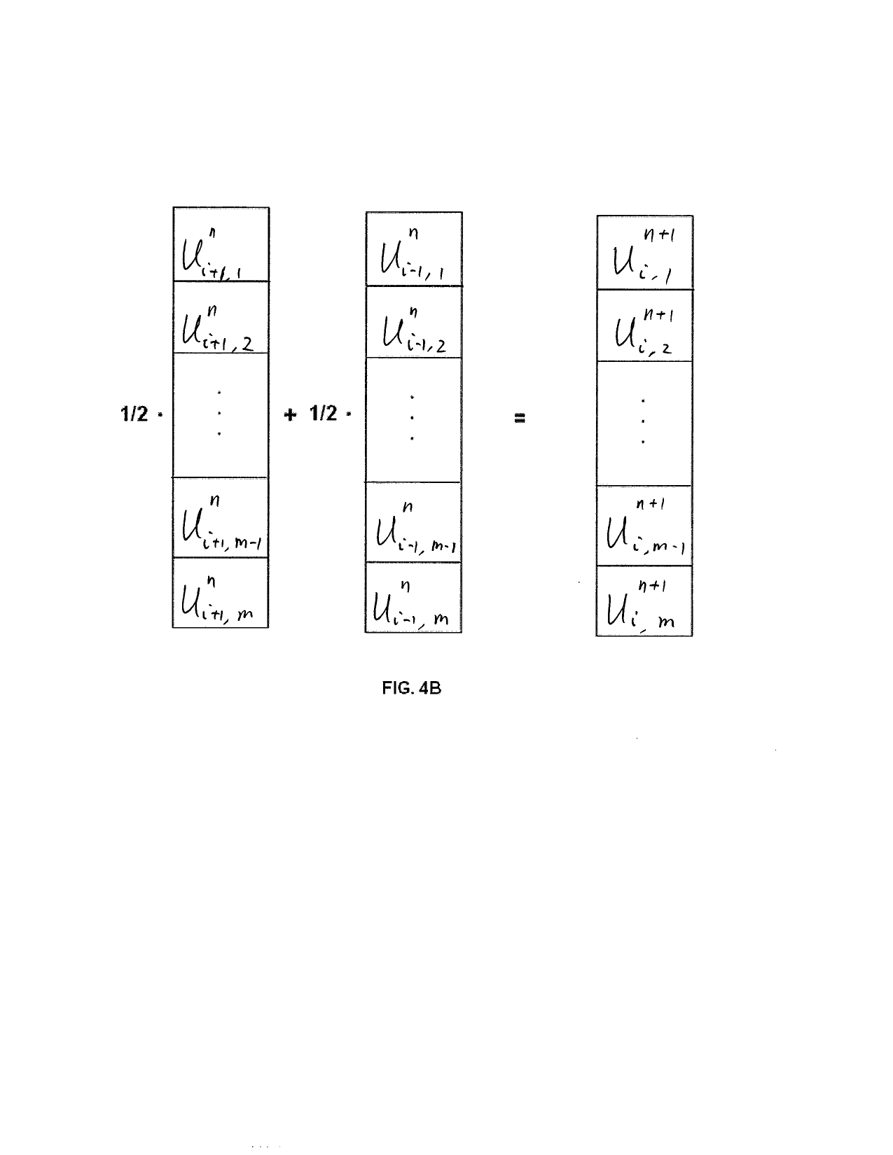

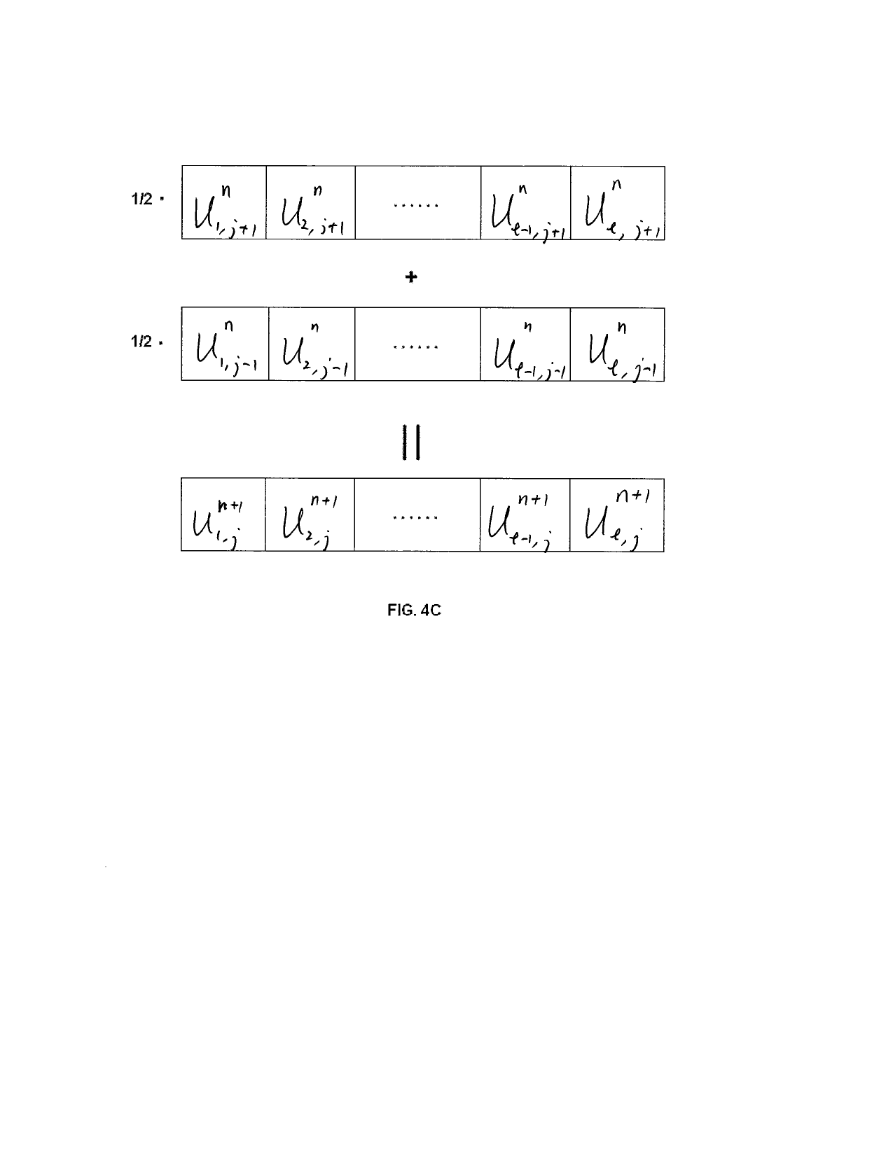

Referring now to the drawings, and more particularly to FIGS. 4A-4C, shown therein is the method of the new image decryption. To carry out the decryption, we use decryption key (r, s): decrypting the encrypted image along x-direction r times, and decrypting the encrypted image along y-direction s times. FIG. 4A is the flow chart.

FIG. 4B is a diagram to show one iteration of decrypting an encrypted image along x-direction. The first and the last column will be kept the same. Other new column is obtained as the average of the column before it and the column after it from the encrypted image or previous decrypting iteration.

FIG. 4C is a diagram to show one iteration of decrypting an encrypted image along y-direction. The first and the last row will be kept the same. Other new row is obtained as the average of the row above it and the row below it from the encrypted image or previous decrypting iteration.

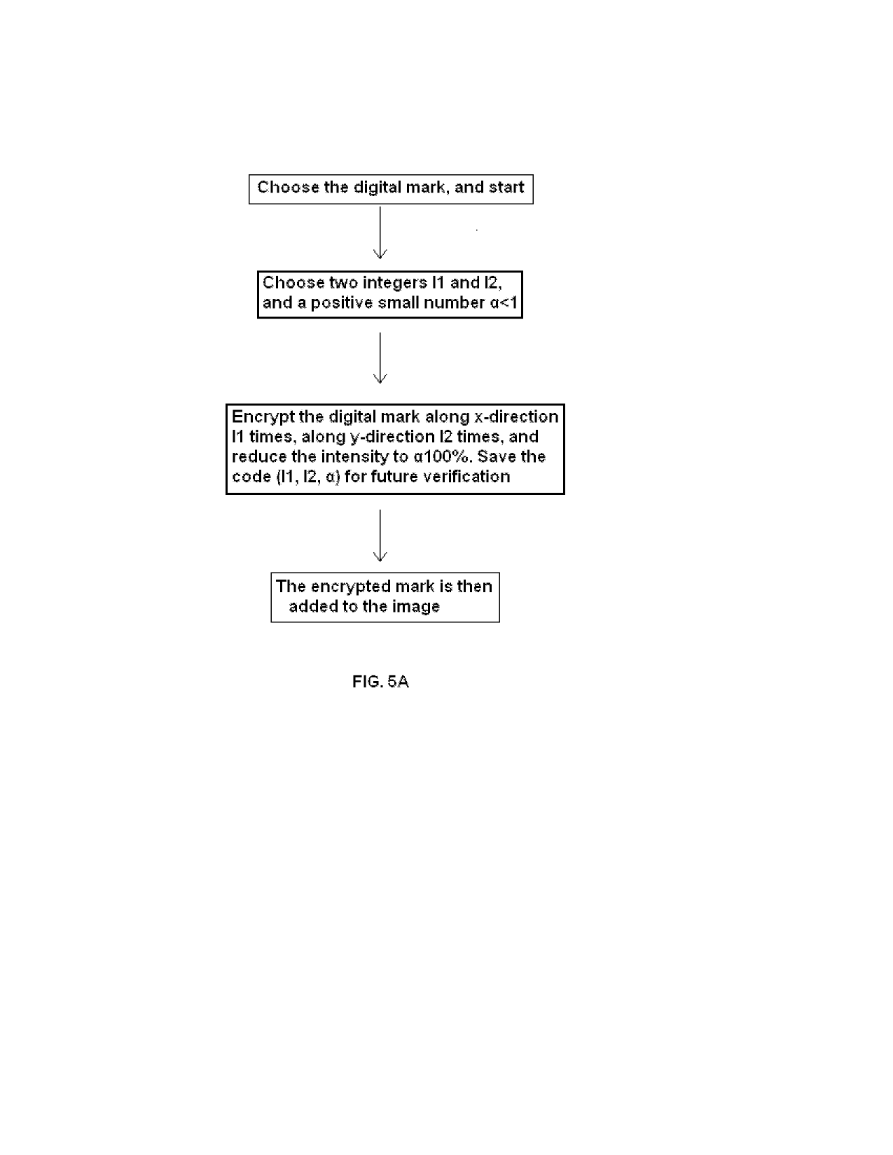

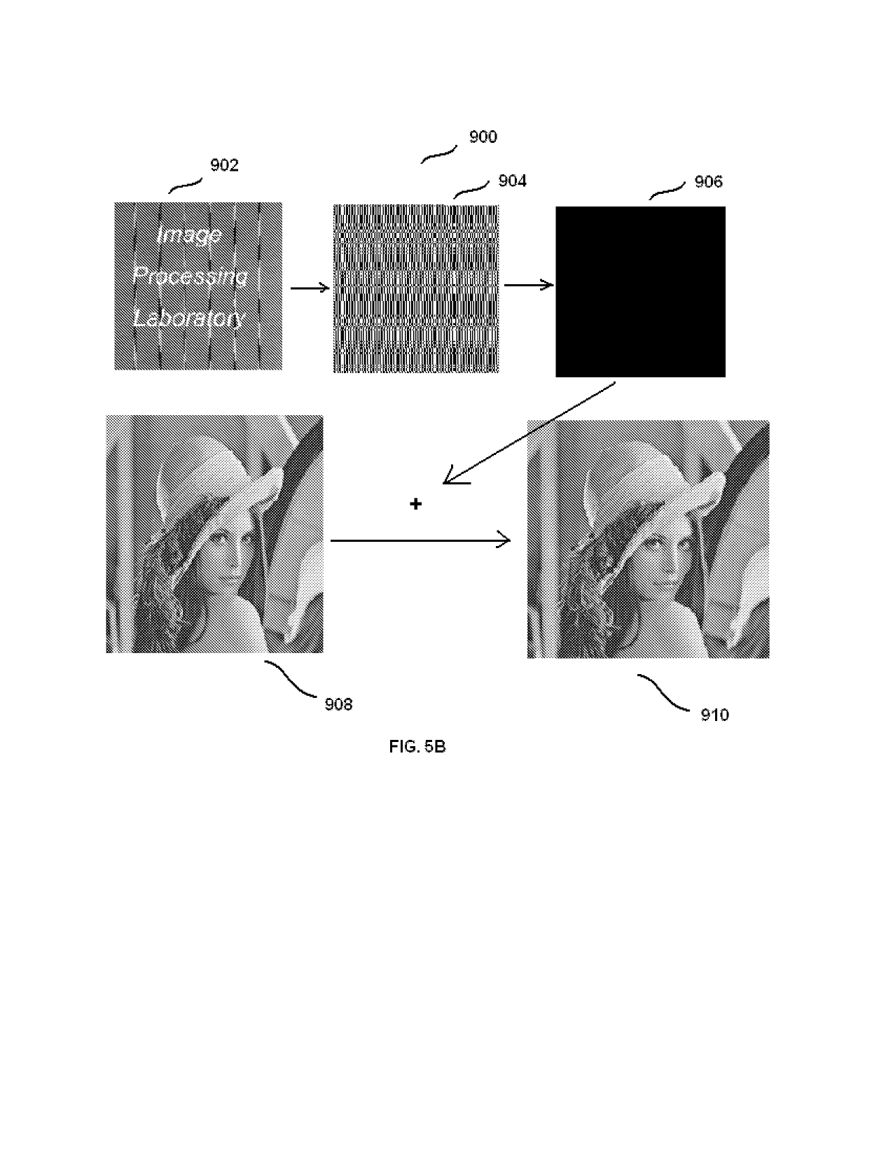

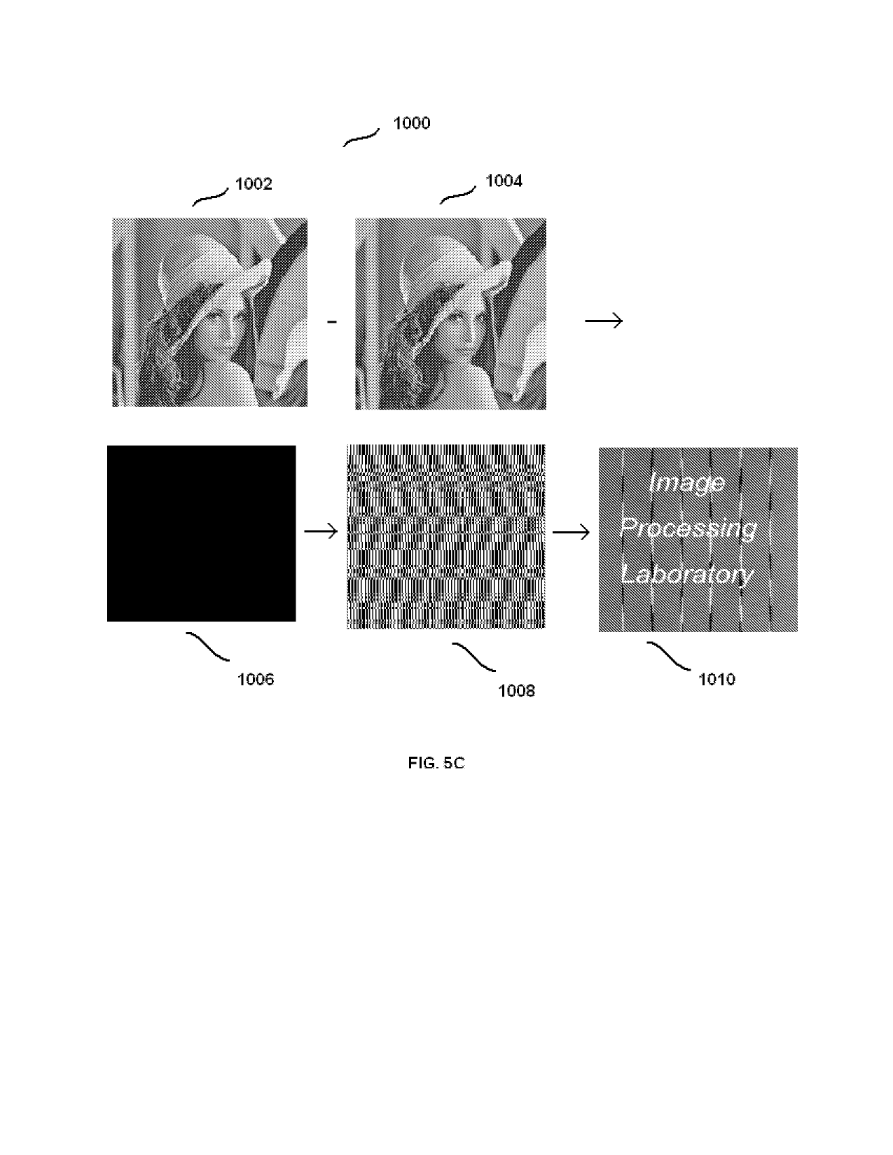

FIG. 5A is the flow diagram illustrating how to obtain an invisible watermarked image.

FIG. 5B is a diagram to show how to obtain an invisible watermarked image. The mark 902 first is encrypted into mark 904, and the intensity of the encrypted mark is reduced α 100% so that the resulting image 906 is invisible. The invisible encrypted mark 906 is then added to the carrier image 908 to obtain a watermarked digital image 910.

FIG. 5C is a diagram to show how to recover the watermark from an image with digital watermark. The different image 1006 is obtained from the marked image 1002 and the original image 1004. The intensity of the difference is increased to (1/α)100% to obtain the encrypted image 1008, and then image 1008 is decrypted to recover the mark image 1010.

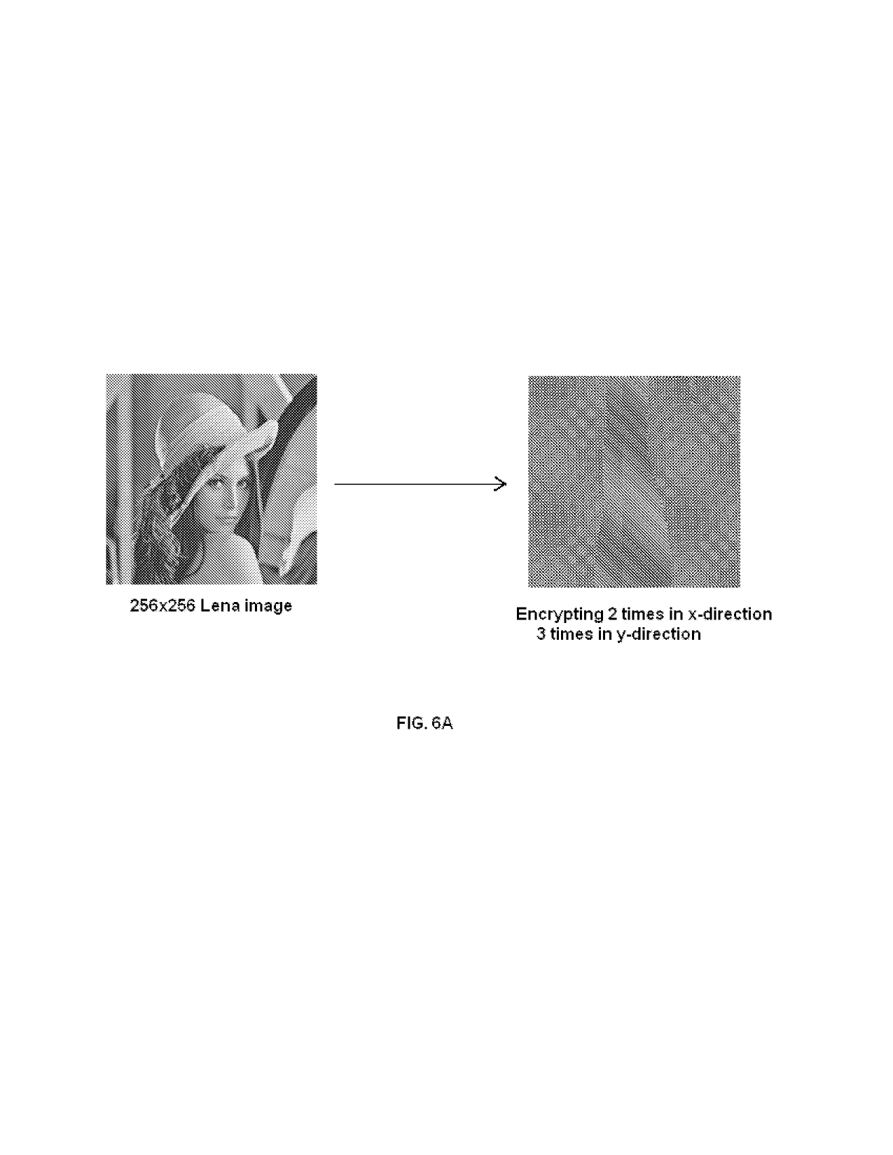

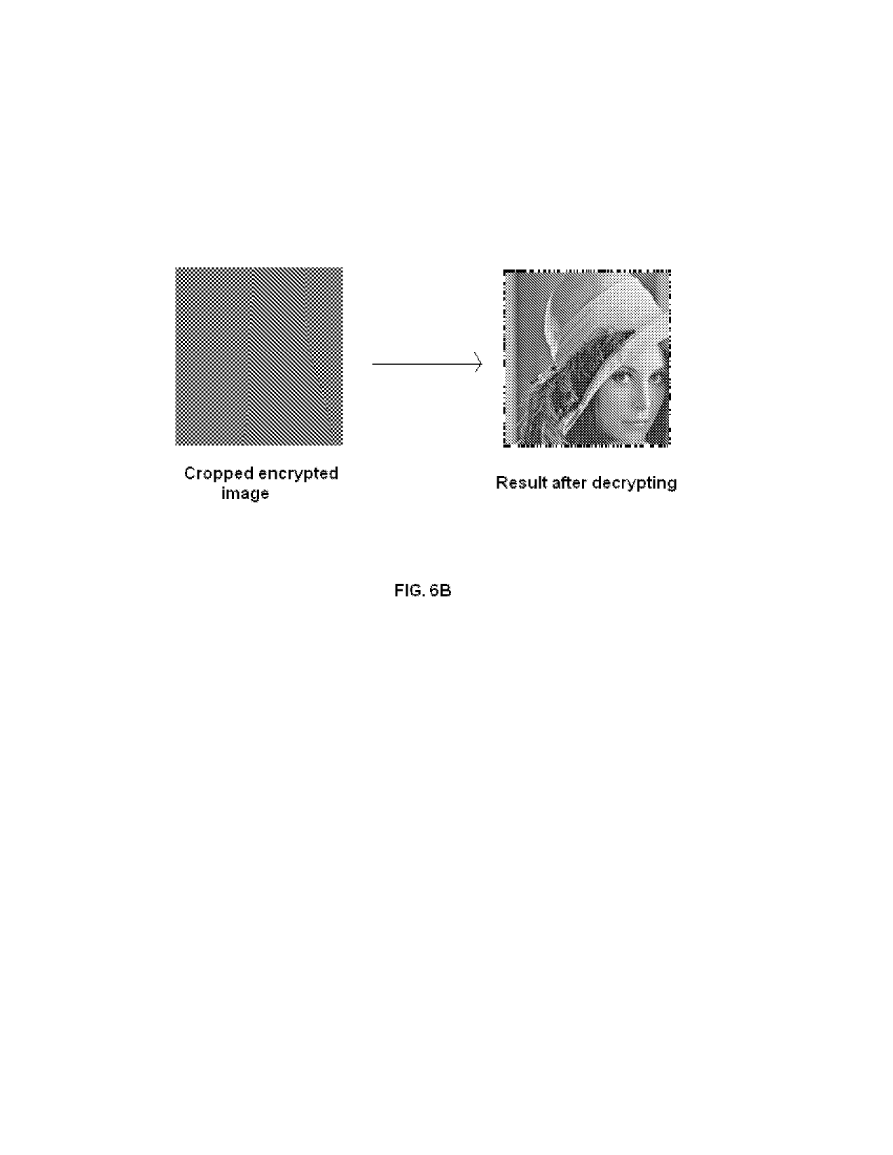

FIG. 6A is a diagram to show the result after encrypting the standard 256×256 Lena image with key (2,3).

FIG. 6B is a diagram to show that the part of Lena image can be recovered from a part of encrypted image after it is decrypted using key (2,3).

What is claimed is:

1. A new system for image/signal encryption and decryption comprising:
a) Column operation (5ₒ)-(5ₑ) for encryption;
b) Row operation (6ₒ)-(6ₑ) for encryption;
c) Column operation (7) for decryption;
d) Row operation (8) for decryption.

2. The encryption/decryption system of claim 1 wherein the column and row operations for encryption and decryption are obtained from formula (2) and (3) using different step length δ.

3. The encryption/decryption system of claim 1 wherein the column and row operations for encryption and decryption are used for various times to achieve better results.

4. The encryption/decryption system of claim 1 wherein the column and row operations for encryption and decryption are used with variety of starting and ending columns and rows for encrypting part of image/signal.

5. A new system for image/signal encryption and decryption using algorithm (4ₓ) or (4_{y}) with a non singular matrix A_{(l-2)×(l-2)} or B_{(m-2)×(m-2)}.

6. The encryption/decryption system of claim 2 wherein algorithm (4ₓ) or (4_{y}) with a non singular matrix A_{(l-2)×(l-2)} or B_{(m-2)×(m-2)} are used for various times to achieve better results.

7. The encryption/decryption system of claim 2 wherein algorithm (4ₓ) or (4_{y}) with a non singular block matrix from A_{(l-2)×(l-2)} or B_{(m-2)×(m-2)} is used for various times to encrypt part of image/signal.

8. A digital watermark system which comprises
a) the encryption/decryption system of claim 1; and
b) the procedure for obtaining digital watermarked image by adding encrypted digital mark into original image; and
c) the procedure for verifying digital mark by subtracting the original image from the image with watermark, and then decrypting the difference.

9. The digital watermark system of claim 8 wherein the encrypted mark has different size to the image.

10. The digital watermark system of claim 8 wherein the verifying procedure is performed on a cropped image with the embedded watermark.
